(19) United States
(12) Patent Application Publication
(10) Pub. No.: US 2010/0069117 A1
(43) Pub. Date: Mar. 18, 2010

(54) USB enabled mobile phone handset

(76) Inventor: Mark S. Knighton, Santa Monica, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/233,496

(22) Filed: Sep. 18, 2008

(51) Int. Cl. H04M 1/00

(52) U.S. Cl. 455/557; 455/572; 455/566

(57) ABSTRACT

A mobile phone handset or handheld device with a connector that enables a direct connection with another device without the need for a separate cable. The connector can be a universal serial bus (USB) connector or similar connector. The connector can move between a stowed position within the housing of the mobile phone handset and a deployed positions where it protrudes from the mobile phone handset.

### TECHNICAL FIELD

Embodiments of the present invention relate to communication between a mobile handset and other devices. Specifically, embodiments relate to a mobile handset with a connector to connect the mobile handset to another device without the use of a separate cable.

### BACKGROUND

Cellular phones are capable of communcating with other devices such as desktop computers to exchange data. These phones are often connected to desktop computers to synchronize calendars, contact lists and email between an application on the desktop computer and applications on the cellular phone. The cellular phones exchange data with the desktop via a direct communication connection.

The cellular phones include a communication port for providing the direct connection to desktop computers. The communication port is either a proprietary communication port develeoped by the manufacturer of the cellular phone or a female universal serial bus (USB) port (i.e., a USB receptacle). Most devices that include a USB port, including cellular phones have female or receptacle ports. A cable having male plugs at both ends is then utilized to connect devices that have the female USB receptacles. The USB ports of cellular phones follow this design. The USB ports are female receptacles and a USB cable having male plugs at each end is required to connect the cellular phone to a desktop computer. Cellular phones with proprietary communication ports are connected using proprietary cabling. The cabling connects the ports to a serial port, parallel port or USB port on a desktop computer. These proprietary port designs are also female receptacles. Female receptacles are utilized to avoid protuding parts that would can be damaged or that inconvenience a user (e.g., snagging on clothing or holsters.)

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1A is a diagram of one embodiment of a mobile phone handset with a stowed USB connector.

FIG. 1B is a diagram of one embodiment of a mobile phone handset with a deployed USB connector.

FIG. 2A is a diagram of one embodiment of a mobile phone handset with a stowed USB connector.

FIG. 2B is a diagram of one embodiment of a mobile phone handset with a deployed USB connector.

FIG. 2C is a diagram of one embodiment of a mobile phone handset with a stowed USB connector.

FIG. 2D is a diagram of one embodiment of a mobile phone handset with a deployed USB connector.

FIG. 3A is a diagram of removable USB connector.

3B is a diagram of the removable USB connector is a flexed position.

FIG. 3C is a diagram of one embodiment of a mobile phone handset with the removable USB connector attached to the communication port.

FIG. 3D is a diagram of one embodiment of a mobile phone handset with a slot for holding a removable USB connector.

FIG. 3E is a diagram of one embodiment of a mobile phone handset with the USB connector being inserted into the slot.

FIG. 3F is a diagram of one embodiment of a mobile phone handset with the USB connector stowed within the slot defined by the phone.

FIG. 4 is a diagram of one embodiment of a mobile phone directly connected with a laptop computer.

FIG. 5 is a diagram of one embodiment of the components of a mobile phone handset.

### DETAILED DESCRIPTION

Described herein is a mobile phone handset or similar handheld device with a data port connector that enables a direct connection with another device without the need for a separate cable. The data port connector can be a universal serial bus (USB) connector, an IEEE 1394 connector or similar communication medium connector. The data port connector can move between a stowed position and deployed position. In the stowed position the connector is disposed entirely or partially within a housing of the handheld device. The connector can be hidden by a door, lid, flap or similar structure. In the deployed position the connector protrudes from the housing of the handheld device to allow it to be inserted into a receiving port of another device. In another embodiment, the connector is removably coupled to the port of the handheld device. The removable connector can be stowed within a compartment defined by the housing of the handheld device.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

The structures and features presented herein are not inherently related to any particular handheld device, mobile phone handset or other apparatus. Various systems may be modified or designed to incorporate the features and structures described herein. The required structure and features for these systems will appear from the description below.

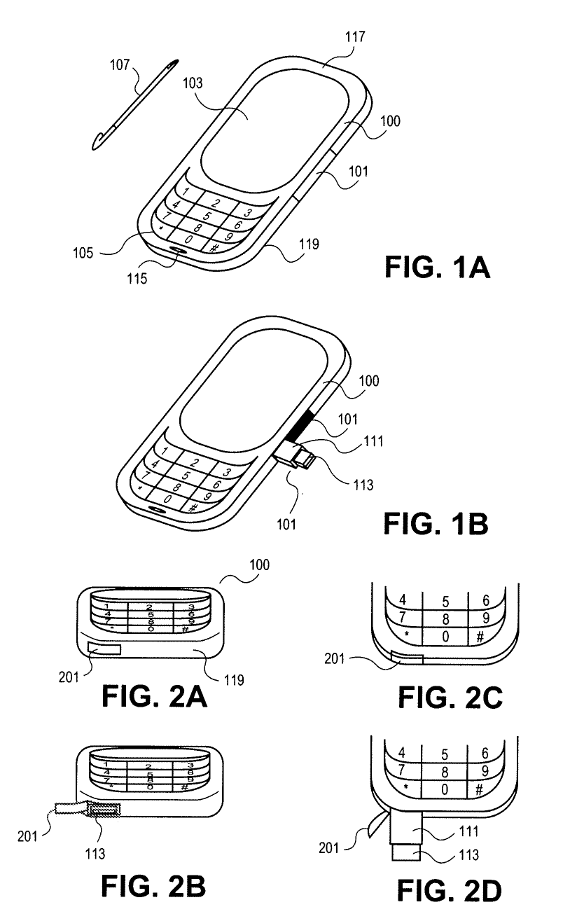

FIG. 1A is a diagram of one embodiment of a mobile phone handset with a stowed USB connector. Any type of handheld device can be designed or modified for use with the principles, features and structures described herein. For sake of clarity, an example of a mobile phone handset (e.g. a cellular phone) is presented herein. However, one skilled in the art would understand that the principles, features and structures described in relation to the mobile phone handset can be applied to other similar devices such as personal digital assistants (PDAs), pagers, handheld gaming devices and similar handheld devices.

The mobile phone handset 100 can be of any type or style. The illustrated example mobile phone handset 100 is a standard flat phone with a keypad 105 and display 103. A microphone 115 and speaker 117 are also present and positioned within the housing 119 of the mobile phone handset 100. In other embodiments, the mobile phone handset 100 can be a flip phone, slide phone, tilt phone or similar style of mobile phone handset.

The mobile phone handset 100 can have any number and type of input devices coupled to or disposed within the housing 119. Any type and size of keypad can be included such as a basic numeric keypad, a QWERTY keyboard, a thumbpad or similar types of keypads. Other types of input devices can include a touchscreen 103 (e.g., a multi-touch screen), touchpad, voice recognition module, a pointer device (e.g., a mini-stick, directional pad or similar device), image capture device (e.g., a camera or similar device) or similar types of input devices. Accessories can also be attached or provided with the mobile phone handset 100 such as a stylus 107, faceplate (original or replacment), jackets or cases or similar accessories.

The mobile phone handset 100 also includes a direct communication port connector 101. The connector 101 can be a USB connector, IEEE 1394 connector, specialized proprietary connector or other type of connection port. The illustrated connector 101 is shown in a stowed position. In the stowed position, the connector 101 may be hidden from view and stored within the housing 119 of the mobile phone handset 100.

FIG. 1B is a diagram of one embodiment of a mobile phone handset with a deployed USB connector. In this illustration, the connector is shown in a deployed position. The example connector 101 is hingedly connected to the mobile phone handset 100. The connector 101 can be attached and movable relative to the housing 119 using any type of mechanism including hinges, ball and socket, rails, spring loaded mechanisms, detents and similar mechanisms that allow the connector to move relative to the housing from a first position entirely or partially disposed within the housing 119 to a second position extending out of or protuding from the housing 119 thereby exposing the connector 101 to allow it to be inserted into the receptacles of other devices.

In the illustrated embodiment, the connector 101 is a USB connector 113 at the end of an arm 111. The plug or sheath of the USB connector 113 fits into a USB receptacle of another device in a form fit. The arm 111 can be formed of any materials or set of materials that provide strength and rigidity sufficient to support the weight of the mobile phone handset 100 when the USB connector 113 is inserted into a USB port of another device such that the arm 111 and USB connector 113 are supporting the weight of the mobile phone handset 100. The arm 111 may have a metal frame or skeleton that is covered by a plastic, resin or rubber shell or casing.

FIG. 2A is a diagram of one embodiment of a mobile phone handset with a stowed USB connector. In this embodiment, the connector is housed within the housing 119 when in a stowed position and held in the stowed position by a detent. The connector may be spring-loaded or similarly biased to a deployed position. The compartment storing the connector can be covered by a flap 201, door, lid or similar covering. The covering can be flipped, slid, removed or similarly moved to expose the compartment storing the connector.

The connector may be released by placing pressure on the connector thereby releasing the detent or similar mechanisms. The connector then moves to the deployed position via the biasing force. Pressing on the connector can return the connector to its stowed position where it is held in place by the detent.

FIG. 2B is a diagram of one embodiment of a mobile phone handset with a deployed USB connector. This illustration shows that the flap 201 has rotated to expose the compartment storing the connector. The connector has been released and is in a deployed position. The connector sheath 113 extends beyond the housing 119 of the mobile phone handset with sufficient clearance to allow it to be placed into a complimentary receptacle.

In one embodiment, the movement of the connector is linear. The biasing force is in line with the central axis of the connector. In other embodiments, the connector may be deployed by a biasing force that rotates or slides the connector to a deployed position from the stowed position. This biasing force may be tangential to the central axis of the connector or similarly positioned relative to the central axis of the connector or similarly positioned relative to the central axis of the connector.

FIG. 2C is a diagram of one embodiment of a mobile phone handset with a stowed USB connector. This diagram illustrates the mobile phone handset in the stowed position from a front view. This embodiment includes a sliding cover 203. Sliding the cover 203 can automatically release the connector, which then deploys.

FIG. 2D is a diagram of one embodiment of a mobile phone handset with a deployed USB connector. Similar to FIG. 2C, this diagram illustrates the mobile phone handset in the deployed position. The covering 203 has slid to allow the connector to deploy. The connector is attached to an arm 111 that is connected with the biasing force. Depending on the connector type, the connector includes a sheath 113 or similar structure at the end of the arm 111 that forms a plug. The sheath 113 and connector extend beyond the outer housing to allow the connector to be plugged into a complementary communication receptacle.

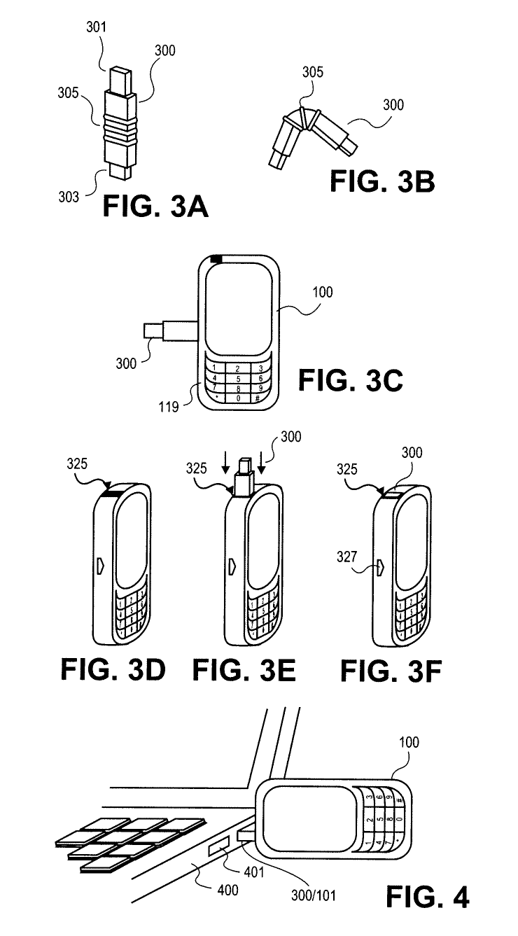

FIG. 3A is a diagram of removable USB connector. The removable connector 300 can have any size including any length or width. The connector 300 can be formed from any materials including plastics, resins, synthetic materials and other materials. The types of ports 301, 303 at each end of the connector 300 can be identical or can be of different types. For example, one port can be a standard-A USB plug 303 and the other port can be a mini-B USB plug 301. Any type of plug or receptacle can be used in the connector 300 including mini-A, mini-B, micro-A, micro-B, standard-A or standard-B USB connectors or similar connector or port types of other communication protocols such as IEEE 1394.

In one embodiment, the connector 300 has a rigid construction and has a length to provide any required clearances from a receptacle. The connector 300 can also have a telescoping design to provide any length while still allowing for easy storage in the housing. In a further embodiment, the connector 300 may have a flexible construction. A portion or the whole of the connector may be flexible. A portion 305 of the connector may be adjustable to different flex points. The internal wiring may utilize flex cable or similar wiring that allows for the expansion from telescoping or the bending of the connector 300.

FIG. 3B is a diagram of the removable USB connector in a flexed position. The connector 300 is illustrated in a flexed state. The flexed position may require force such as external pressure or the weight of the attached components to maintain the position. In another embodiment, the flexed position may be held by the structure of the connector. The connector structure may define specific locking positions or may be bendable to any position that will hold. A mechanical structure or the materials of the connector 300 provide this functionality by defining flex positions or providing the resilient structure of the connector that maintains a desired flex position.

FIG. 3C is a diagram of one embodiment of a mobile phone handset with the removable USB connector attached to the communication port. The connector 300 can attach to any complimentary communication port of the mobile phone handset 100. The mobile phone handset 100 can have a communication port in any part or position in the housing 119.

FIG. 3D is a diagram of one embodiment of a mobile phone handset with a slot for holding a removable USB connector. The slot 325 can be of any size or shape that is complimentary to the dimensions of the connector. The slot 325 can have a cover or lid or the connector can form a part or a whole of a cover or lid when within the slot 325.

FIG. 3E is a diagram of one embodiment of a mobile phone handset with the USB connector being inserted into the slot. The connector 300 can slide into the slot 325 or similarly be fit into the slot. The connector 300 can be held in the slot by a form fit, snap fit, interlocking components, detents or similar mechanisms.

FIG. 3F is a diagram of one embodiment of a mobile phone handset with the USB connector stowed within the slot defined by the phone. In a stowed position the connector 300 may not be visible within the slot 325. The connector 300 may be released by application of force to the connector 300 or a release mechanism such as a button to release the detent, by gripping a protrusion connected to the connector 500 or by similar release mechanisms.

The communication port 327 can be exposed or similarly covered by a cap, door, flap or similar mechanism when the connector 300 is not inserted into the communication port 327. The communication port 327 can be positioned on any part of the housing of the mobile phone handset.

FIG. 4 is a diagram of one embodiment of a mobile phone directly connected with a laptop computer. The mobile phone handset 100 and removable or internal connector 300/101 can be designed to connect with any other device 400. The design may include an orientation of the connector 300/101 and communication port to prevent the blocking of adjacent communication ports 401.

The connector 300/101 can also be constructed of materials and have casing and framework (e.g., in the arm and sheath of the connector 300/101) that supports the weight of the mobile phone handset 100. The length, plug size and similar characteristics can be designed to support the weight of the mobile phone handset 100 as well as to minimize shearing and similar stresses on the connector 300 and attached device 400. For example, a surface of the plug adjacent to the receiving receptacle may be enlarged to distribute the force of the weight of the mobile phone handset 100 away from the attached receptacle.

The direct connection to a laptop 400 or similar host enables data exchange between the host and the mobile phone handset 100 and battery recharge using the power provided through the direct connection. The exchange of data may be automatic or controlled by the user or an application on either the mobile phone handset 100 or the host. Any number of applications on the host and mobile phone handset 100 can use the direct connection to exchange data. Any amount of data can be exchanged.

The recharge of the mobile phone handset battery can be continuous while the direct connection is made between the mobile phone handset 100 and the host. Any amount of power can be drawn over the connection. In one embodiment a USB connection provides a 4.75 v to 5.25 v 500 mA power source. In one embodiment, the connector 300/101 is the primary or only connector or port for interfacing with an external power source for charging the mobile phone handset 100.

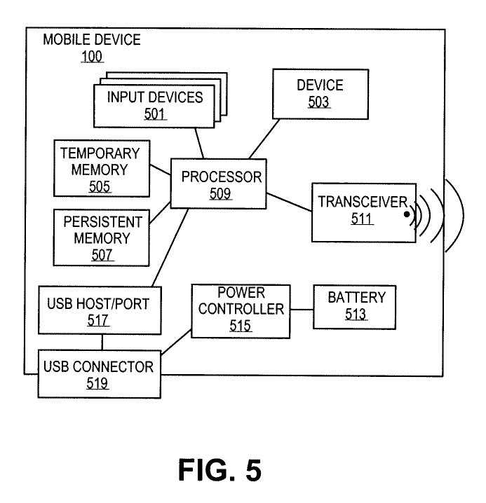

FIG. 5 is a diagram of one embodiment of a mobile phone handset. The components of the mobile phone handset 100 include a processor 509, temporary memory 505, persistent memory 507, input devices 501, display devices 503, transceivers 511, a battery 513, power controller 515, a communication port or controller 517, a connector 519 and similar components.

The processor 509 can be any general purpose processor or application specific integrated circuit (ASIC) suitable for use in the mobile phone handset 100. The processor 509 may be specifically designed for use in mobile phone handsets 100 or may be designed for use in different types of handheld or mobile devices. The processor 509 executes applications and programs within the mobile phone handset and facilitates the communication of data amongst the other components of the mobile phone handset 100.

The temporary memory 505 may be any type of random access memory (RAM) including flash devices, static RAM devices, dynamic RAM devices and similar memory devices. The temporary memory 505 is utilized by the processor 509 to store data such as program data documents, images and similar data that the processor is currently accessing or utilizing. The temporary memory 505 may be a ‘working memory’ for the processor.

A persistent memory 507 may be any type of storage device such as a read only memory (ROM), flash device or similar storage device that can store data across power-on/off cycles. The persistent memory 507 is utilized to store applications and data that are to be retained over long time periods or are necessary for the operation of the device. The processor 509 loads data from the persistent memory 507 to the temporary memory 505 when needed for modification. The persistent memory 507 may be slower or non-modifiable in contrast to the temporary memory 505, which may have faster access times and allow for modification.

Both the temporary memory 505 and persistent memory 507 can be partially or completely embodied in removable storage devices. Complementary receptacles or ports are included in the mobile phone handset 100 to receive the removable storage devices. The removable storage devices may be flash devices or similar devices such as SD memory cards, Memory Sticks by Sony Corporation or similar devices.

The mobile phone handset 100 can include any number of input devices 501. Input devices 501 can include keypads, touch screens, voice recognition components, microphones, buttons, cameras and similar input devices. The input devices 501 can vary based on the functionality and features to be offered by the mobile phone handset 100. The processor 509 receives input data from each of these input devices 501 and processes the input according to the appropriate application or program.

Any number of display devices 503 can be present in the mobile phone handset 100. Display devices can include display screens such as liquid crystal display (LCD) devices, light emitting diodes (LEDs), and similar display devices. The display devices are driven by the processor or by the processor in combination with a graphics processor or similar components. The display devices can also encompass input devices such as touch screens or multi-touch screens.

The mobile phone device 100 includes at least one transceiver 511. The transceiver 511 performs cellular communications. Other types of communication may be performed by the transceiver or other transceivers within the mobile phone handset 100. Other types of wireless communication that are suggested can include 802.11 b/g/n, Bluetooth, Infrared and similar wireless technologies.

A battery 513 can be any type of rechargeable battery, such as a Nickel-Cadmium, Lithium-Ion, fuel cell or similar battery technology. The battery 513 power is utilized by all of the components of the mobile phone device 100. A power controller 515 manages the distribution of the power of the battery to the other components and the recharging of the battery from outside sources such as AC and DC power inputs. The power controller is also connected to the communications port 517 or connector 519 to draw input power from the connector. Communication technologies such as USB include power transmission. The power controller can utilize the power transmission of the connector to charge the battery 513.

The communication port 517 (e.g., a USB host controller and port) manage the communication of data with connected devices through the connector according to the communication protocols of the technology. The communication port 517 can communicate with another device through the connector 519 or through cabling plugged into the port. The connector as discussed herein is a direct connection with an attached device. In one embodiment, the USB connector is an integrated male USB plug that connects to a female USB receptacle of another device.

Thus, a method and apparatus for an integrated direct connection has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A mobile phone handset comprising:
a housing defining a battery compartment;
a user input device coupled to the housing;
a transceiver retained within the housing; and
a universal serial bus (USB) connector integrally coupled with the housing to permit direct connection between the handset and a host USB port without a cable or adaptor.

2. The handset of claim 1 further comprising:
a control to draw current from the host USB port to charge a battery residing within the battery compartment.

3. The handset of claim 1 further comprising:
a processor and a memory within the housing to transfer data through the USB connection between the handset and a host device.

4. The handset of claim 1 wherein the user input device comprises at least one of:
a keypad;
a touch screen;
a voice command recognition module; and
a pointer device.

5. The handset of claim 1 further comprising:
a coupling to permit the connector to transition between a stowed position and a deployed position.

6. The mobile phone handset of claim 5 wherein in the deployed position the connector protrudes from the housing and wherein the transition between the deployed and the stowed position is along a substantially linear path.

7. The mobile phone handset of claim 5 further comprising:
a hinge to permit the connector to pivot between the deployed position and the stowed position.

8. The mobile phone handset of claim 5 wherein in the stowed position, the housing contains substantially all of the connector.

9. A mobile phone handset comprising:
a USB connector having a first end to connect to a host USB port and a second end to connect to a port in the mobile phone;
a housing defining a stowage area for the USB connector and a communication port.

10. The mobile phone handset of claim 9 wherein the connector is sufficiently flexible to bend to at least a substantially right angle.

11. The mobile phone handset of claim 9 wherein the connector can support a weight of the handset when coupled to the USB host port.

12. The mobile phone handset of claim 10 wherein the connector comprises:
a flat flex cable.

13. The mobile phone handset of claim 10 wherein the connector comprises:
a hinge.
